(19) United States
(12) Patent Application Publication
(10) Pub. No.: US 2004/0187377 A1
(43) Pub. Date: Sep. 30, 2004

(54) Glueboard for rodents

(75) Inventor: James P. Gardner JR., Stillwater, MN (US)

Correspondence Address: IPLM GROUP, P.A., POST OFFICE BOX 18455, MINNEAPOLIS, MN, 55418, US

(73) Assignee: Ecolab Inc.

(21) Appl. No.: 10/396,754

(22) Filed: Mar. 24, 2003

(51) Int. Cl. A01M 1/14

(52) U.S. Cl. 43/114

(57) ABSTRACT

A glueboard (10, 110) includes a base member (11, 111) and a quantity of rodent arresting adhesive (12, 112). A first quantity of securing adhesive (15, 115) is operatively connected to the bottom surface of the base member (11, 111), wherein the glueboard (10, 110) is attachable to a contact surface (201, 301).

### BACKGROUND OF THE INVENTION

1. Field of the Invention

This invention relates generally to glueboards for rodents, and more particularly to a glueboard that may be utilized in a variety of orientations.

2. Description of the Prior Art

Glueboards have been used for some time in trapping rodents, such as rats and mice. The glue traps are well known and have a layer of extremely sticky pressure sensitive adhesive on a suitable backing or support, such as a board or tray. In use, the trap is positioned on a floor or other support surface where the rodent is active. The rodent is attracted on to or otherwise steps on the adhesive surface, thereby trapping the rodent.

However, these traps and glueboards have an efficacy that is limited due to the locations available for placement relative to where the rodents are actually traveling. Rodents may run up and down vertical pipes between building levels as well as running on structural I-beams and horizontal electrical conduits. The prior art glueboards or trays do not conform to a circular pipe and also do not rest securely on either a vertical or horizontal pipe. Additionally, even on horizontal I-beams, which have a generally horizontal surface, once a rodent interacts with the glueboard, the rodent is less likely to become trapped as the glueboard is not easily anchored and often falls off of the beam.

The present invention addresses the problems associated with the prior art and provides for a glueboard and a method of using the glueboard for trapping rodents on various surfaces.

### SUMMARY OF THE INVENTION

In one embodiment, the invention is an article for entrapping rodents. The article includes a base member having a top surface and a bottom surface. The quantity of rodent arresting adhesive is operatively connected to the top surface. A quantity of rodent arresting adhesive is sufficient to restrain movement of a rodent. A first quantity of securing adhesive is operatively connected to the bottom surface, wherein the article is attachable to a contact surface.

In another embodiment, the invention is a glueboard for entrapping rodents. The glueboard has a flexible base member having a top surface and a bottom surface. A quantity of rodent arresting adhesive is operatively connected to the top surface, the quantity of rodent arresting adhesive is sufficient to restrain movement of a rodent. A first quantity of securing adhesive is operatively connected to the bottom surface, wherein the glueboard is attachable to a contact surface.

In another embodiment, the invention is a method of attaching a glueboard to a contact surface. The glueboard has a flexible base member having a top surface with a quantity of rodent arresting adhesive and a bottom surface with a quantity of securing adhesive. A method includes positioning the glueboard proximate the contact surface with the securing adhesive next to the contact surface and contacting the securing adhesive to the contact surface, thereby securing the glueboard to the contact surface.

In another embodiment, the invention is a method of entrapping a rodent with a glueboard. The glueboard has a flexible base member having a top surface and a quantity of rodent arresting adhesive and a bottom surface with a quantity of securing adhesive. The method includes determining a likely path for a rodent on a contact surface. The glueboard is positioned proximate the contact surface with the securing adhesive next to the contact surface and contacting the securing adhesive to the contact surface, thereby securing the glueboard to the contact surface.

In another embodiment, the invention is a method of attaching a glueboard to a contact surface. The glueboard has a flexible base member having a top surface with a quantity of rodent arresting adhesive and a bottom surface. The method includes wrapping the flexible base member completely around the contact surface, wherein a portion of the bottom surface overlies the top surface. The bottom surface contacts the rodent arresting adhesive, thereby securing the glueboard around the contact surface.

### BRIEF DESCRIPTION OF THE DRAWINGS

FIG. 1 is a perspective view of the glueboard of the present invention;

FIG. 2 is an enlarged side elevational view of a portion of the glueboard shown in FIG. 1;

FIG. 3 is a bottom plan view of the glueboard shown in FIG. 1;

FIG. 4 is a perspective view showing the glueboard shown in FIG. 1 secured to a vertical cylindrical contact surface; and

FIG. 5 is a side elevational view of another embodiment of a glueboard secured to a channel member for the contact surface.

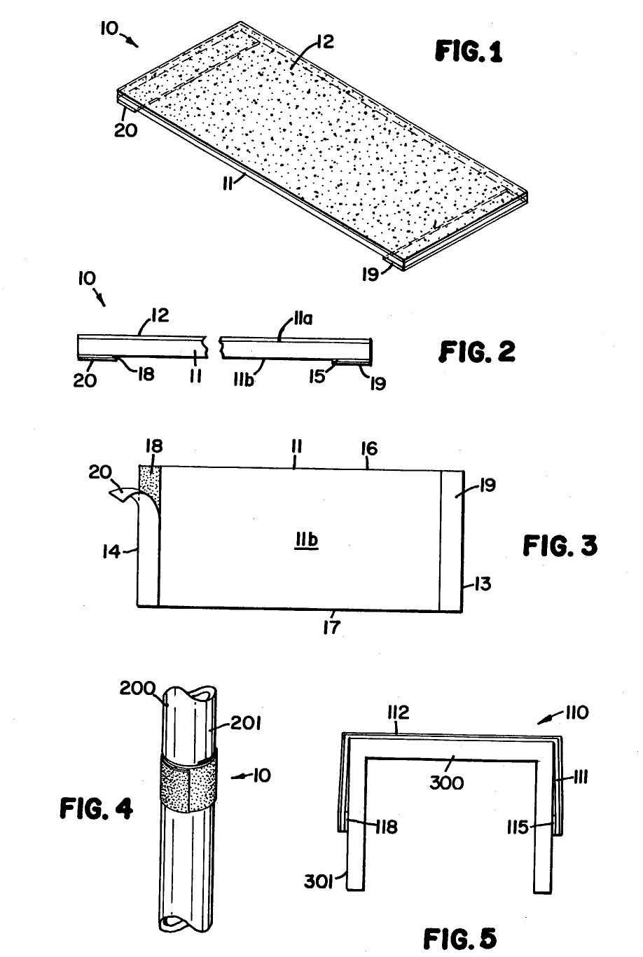

### DETAILED DESCRIPTION OF A PREFERRED EMBODIMENT

Referring to the drawings, wherein like numerals represent like parts throughout the several views, there is generally disclosed at 10 a glueboard. The glueboard 10 includes a base member 11 having a top surface 11a and a bottom surface 11b. The base member 11 is preferably flexible, although it may be rigid. If the base member 11 is flexible, the glueboard 10 is more versatile in its application, as will be described more fully hereafter. However, in other applications, such as where the glueboard 10 is in a preform condition, the base member 11 may be more rigid. The base member is shown as a sheet, but it is understood that other configurations may also be used, such as a shallow tray. A quantity of rodent arresting adhesive 12 is operatively connected to the top surface 11a, by means well known in the art. The quantity of rodent arresting adhesive is sufficient to restrain movement of a rodent that becomes trapped in the glueboard 10. The quantity and type of adhesive, being well known in the art.

The base member 11 has a first edge 13 and a second edge 14. A first quantity of securing adhesive 15 is operatively connected to the bottom surface 11b proximate the first edge 13. The securing adhesive 15 is shown as a strip that extends from the third edge 16 of the base member 11 to the fourth edge 17 of the base member 11. A second quantity of securing adhesive 18 is operatively connected to the bottom surface 11b proximate the second edge 14. The securing adhesives 15, 16 may be covered by a removable strip 19, 20. While there are shown to be two quantities of securing adhesive, it is understood that only one securing adhesive is necessary for the present invention, in certain embodiments, as will be described more fully hereafter, the second securing adhesive is beneficial. While the glueboard 10 may be of any suitable size, one suitable configuration would be for the glueboard 10 to have a length of approximately 24 inches and a width of 10-12 inches. In such a configuration, the securing adhesives would have a width of approximately one inch. The securing adhesives 15, 18 preferably do not extend across the entire back surface for ease of removal of the glueboard, as will be discussed more fully hereafter.

Materials used for flexible base member include any material capable of supporting a layer of adhesive and maintaining a minimal structural integrity during use. Preferred examples include tagboard, cardboard and coated analogs to allow greater environmental ruggedness, such as resistance to water. Alternative flexible base materials include common industrial plastics, such as HDPE. Typically the extent of flexibility is controlled by the thickness and of the base materials and the extent of tray like edges.

Preferred securing adhesives could be 3M double sticky tape or 3M double sided foam adhesive, however, the invention envisions similar adhesive materials coated directly on the backing. More generally, suitable adhesives are most commonly based on natural rubber-, synthetic rubber-(e.g., styrene/butadiene copolymers and styrene/isoprene/styrene block copolymers), and various (meth)acrylate-(e.g., acrylate and methacrylate) based polymers blended with appropriate tackifiers to render them pressure-sensitive.

The amount of adhesive on the bottom side can range from 90 to 2.5 percent of the surface area. Most preferred, the adhesive covers between 5 and 20 percent of the back side.

A second embodiment of a glueboard 110 is shown in FIG. 5. The glueboard 110 is similar to the glueboard 10, with the exception that the base member 111 is rigid and is not flexible like the base member 11. The base member 111 is in the shape of a preform. The glueboard 111 has securing adhesives 115, 118 to be utilized in securing the glueboard 110 to a contact surface, as will be described more fully hereafter. The base member 111 may also be in the shape of a shallow tray, i.e., having side walls.

In use, the glueboard 10 is positioned so that the bottom surface 11b is proximate the contact surface on which the glueboard is to be placed. Because of one or more securing adhesive strips 15, 18, the glueboard 10 is able to be placed on and secured to a variety of contact surfaces. FIG. 4 shows the glueboard 10 secured to the contact surface 201 of a round pole 200. The pole 200 is shown in a vertical position, for which the glueboard 10 is especially effective. Prior art glueboards could not be placed in a vertical position, thereby not allowing for the entrapment of rodents going up and down a vertical contact surface. Similarly, the adhesive securing strips 15, 18 may be used to secure the glueboard 10 to a variety of surfaces, including horizontal pipes, suspended horizontal beams from which a prior art glueboard could easily fall. Removable strips 19, 20 may be placed over the securing adhesives 15, 18 and removed just prior to being placed on the contact surface. As shown in FIG. 4, one of the strips 19, 20 may be removed and placed against the contact surface 201. The remainder of the glueboard 10 is then wrapped around the pole 200 and the glueboard 10 wraps around on itself and the bottom surface 11b contacts the rodent arresting adhesive 12 to secure the glueboard 10 to itself. This, of course, assumes that the length of the glueboard 10 is sufficient to encircle the pole 200. If not, the second strip 20 may be removed and the securing adhesive 18 is then used to secure the other end of the glueboard 10 to the contact surface 201. By having the securing adhesive 15 secured to only a relatively small portion of the bottom surface 11b, the glueboard 10 is easy to remove. That is, a knife or other sharp instrument can be used to slit the glueboard, where there is no securing adhesive, and it may then easily be removed as only the small securing adhesive 15 and/or 19 needs to be removed. The entire base member preferably does not have the securing adhesive to allow for easier removal.

The use of the glueboard 10 is also quite advantageous in securing a glueboard to a surface that is not generally suitable to direct bonding of an adhesive, such as a dusty or dirty contact surface. The glueboard 10, with a flexible base member 11, is easily secured to such a surface by wrapping the glueboard 10 around and contacting itself, as previously described. The glueboard 10 may or may not have the optional securing adhesives 15 and/or 18. If the securing adhesive 15 and/or 18 is used, it may be used to tack the glueboard 10 in place to the contact surface. Then, the flexible base member 11 is wrapped around the contact surface allowing the bottom side 11b to be attached to the rodent arresting adhesive 12 on the top side 11a and to secure the glueboard 10 in place. It is only necessary that the length of the glueboard be greater than the circumference of the contact surface, so that the glueboard 10 may be wrapped around on itself.

In addition, the glueboard according to the present invention may have a preform shape such as shown in FIG. 5. The glueboard 110 may be manufactured to have any number of desired preform shapes. One instance is shown for use on a channel member 300. The channel member 300 is generally an inverted U-shape and has a contact surface 301 which extends around the outer perimeter of the channel 300. A protective removable strip (not shown, but similar to 19 and 20) is removed and the preform glueboard 110 is placed over the channel 300. The securing adhesives 115, 118 secure the glueboard 110 in position. The specific shape of the preform will, of course, be dependent on the shape of the contact surface on which the glueboard 110 is to be secured.

The above specification, examples and data provide a description of the manufacture and use of the composition of the invention. It will be appreciated by those skilled in the art that other components and configurations that embody the principles of this invention and other applications therefore other than as described herein can be configured within the spirit and intent of this invention. The exact arrangements described herein are provided only as examples of embodiments that incorporate the principles and the practices of this invention. Other modifications and alterations are well within the knowledge of those skilled in the art and are to be included within the broad scope of the appended claims.

I claim:

1. An article for entrapping rodents, comprising:
a) a base member having a top surface and a bottom surface;
b) a quantity of rodent arresting adhesive operatively connected to the top surface, the quantity of rodent arresting adhesive sufficient to restrain movement of a rodent; and
c) a first quantity of securing adhesive operatively connected to the bottom surface, wherein the article is attachable to a contact surface.

2. The article of claim 1, wherein the base member is flexible.

3. The article of claim 1, wherein the bottom surface has a first edge and a second edge, the securing adhesive operatively connected proximate the first edge.

4. The article of claim 3, further comprising a second quantity of securing adhesive operatively connected proximate the second edge.

5. A glueboard for entrapping rodents, comprising:
a) a flexible base member having a top surface and a bottom surface;
b) a quantity of rodent arresting adhesive operatively connected to the top surface, the quantity of rodent arresting adhesive sufficient to restrain movement of a rodent; and
c) a first quantity of securing adhesive operatively connected to the bottom surface, wherein the glueboard is attachable to a contact surface.

6. The glueboard of claim 5, the bottom surface has a first edge and a second edge, the securing adhesive operatively connected proximate the first edge.

7. The glueboard of claim 6, wherein the securing adhesive is on less than 20 percent of the bottom surface.

8. The glueboard of claim 7, further comprising a second quantity of securing adhesive operatively connected proximate the second edge.

9. A method of attaching a glueboard to a contact surface, the glueboard having a flexible base member having a top surface with a quantity of rodent arresting adhesive and a bottom surface with a quantity of securing adhesive, the method comprising:
a) positioning the glueboard proximate the contact surface with the securing adhesive next to the contact surface; and
b) contacting the securing adhesive to the contact surface, thereby securing the glueboard to the contact surface.

10. The method of claim 9, wherein the contact surface is non-planar.

11. The method of claim 10, wherein the contact surface is vertical.

12. The method of claim 11, wherein the contact surface is circular in cross-section.

13. The method of claim 12, further comprising wrapping the glueboard about the contact surface, wherein the bottom surface encircles the contact surface and the bottom surface is positioned over the top surface and the quantity of rodent arresting adhesive adheres the glueboard to itself.

14. A method of entrapping a rodent with a glueboard, the glueboard having a flexible base member having a top surface with a quantity of rodent arresting adhesive and a bottom surface with a quantity of securing adhesive, the method comprising:
a) determining a likely path for a rodent on a contact surface;
b) positioning the glueboard proximate the contact surface with the securing adhesive next to the contact surface; and
c) contacting the securing adhesive to the contact surface, thereby securing the glueboard to the contact surface.

15. The method of claim 14, wherein the contact surface is non-planar.

16. The method of claim 15, wherein the contact surface is vertical.

17. The method of claim 16, wherein the contact surface is circular in cross-section.

18. The method of claim 17, further comprising wrapping the glueboard about the contact surface, wherein the bottom surface encircles the contact surface and the bottom surface is positioned over the top surface and the quantity of rodent arresting adhesive adheres the glueboard to itself.

19. A method of attaching a glueboard to a contact surface, the glueboard having a flexible base member having a top surface with a quantity of rodent arresting adhesive and a bottom surface, the method comprising:
a) wrapping the flexible base member completely around the contact surface, wherein a portion of the bottom surface overlies the top surface; and
b) contacting the bottom surface to the rodent arresting adhesive, thereby securing the glueboard around the contact surface.

20. The method of claim 18, the glueboard further comprising a quantity of securing adhesive secured to the bottom surface, the method further comprising contacting the securing adhesive to the contact surface, whereby the glueboard is tacked in position as the flexible base member is being wrapped around the contact surface.
